(19) United States
(12) Patent Application Publication
(10) Pub. No.: US 2026/0100139 A1
(43) Pub. Date: Apr. 9, 2026

(54) TUTORIAL SYSTEM AND METHOD FOR INTERACTIVE MEDIA

(71) Applicant: Sony Interactive Entertainment Inc., Tokyo (JP)

(72) Inventors: Francesca Leung, London (GB); Dominic Wiggan, London (GB)

(21) Appl. No.: 19/349,040

(22) Filed: Oct. 3, 2025

(30) Foreign Application Priority Data
Oct. 4, 2024 (GB) 2414601.1

(51) Int. Cl. G09B 5/06

(52) U.S. Cl. CPC G09B 5/065

(57) ABSTRACT

A method of content generation to provide a tutorial to a user comprises the steps of configuring an existing game progress monitoring mechanism to record when predefined game events occur, receiving an indication that a tutorial is required for a particular state of the game, determining a purpose of the tutorial based at least in part upon records from the game progress monitoring mechanism, selecting one or more existing content elements related to the game, based at least in part upon the determined purpose of the tutorial, generating the tutorial based upon the one or more selected existing content elements, and providing the tutorial to the user.

### CROSS-REFERENCE TO RELATED APPLICATIONS

This application claims the benefit of priority to U.K. Application No. 2414601.1, filed on Oct. 4, 2024, the contents of which are hereby incorporated by reference.

### BACKGROUND

The present invention relates to a tutorial system and method for interactive media.

Television programmes often provide a recap of the plot of a TV series at the start of the next episode, which has been edited by a director to remind users of key information and plot points relevant to the story as a whole and possibly also the particular episode being shown. The aim of this is to re-familiarise the user with the content of the programme.

By contrast, for videogames it would be preferable if such a re-familiarisation scheme took account of the fact that the videogame is an interactive medium requiring skilled input by the user, rather than a passive medium like television.

The present invention seeks to address or mitigate this problem.

### SUMMARY OF THE INVENTION

Various aspects and features of the present invention are defined in the appended claims and within the text of the accompanying description.

In a first aspect, a method of content generation to provide a tutorial to a user is provided in accordance with claim 1.

In another aspect, an entertainment device for providing a tutorial to a user is provided in accordance with claim 15.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 is a schematic diagram of an entertainment device in accordance with embodiments of the present description;

FIG. 2 is a schematic diagram of a universal data system service of an entertainment device, in accordance with embodiments of the present description;

FIG. 3 is a flow diagram of a method of content generation for recapping a game, in accordance with embodiments of the present description; and

FIG. 4 is a flow diagram of a method of content generation to provide a tutorial to a user, in accordance with embodiments of the present description.

### DESCRIPTION OF THE EMBODIMENTS

A tutorial system and method for interactive media are disclosed. In the following description, a number of specific details are presented in order to provide a thorough understanding of the embodiments of the present invention. It will be apparent, however, to a person skilled in the art that these specific details need not be employed to practice the present invention. Conversely, specific details known to the person skilled in the art are omitted for the purposes of clarity where appropriate.

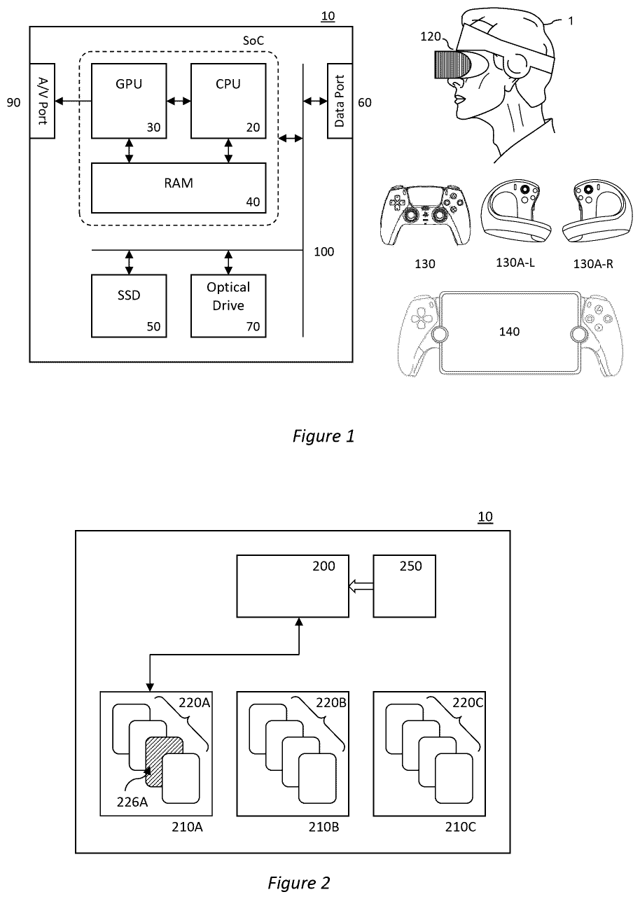

Referring now to the drawings, wherein like reference numerals designate identical or corresponding parts throughout the several views, FIG. 1 shows an example of an entertainment system 10 such as a computer or console.

The entertainment system 10 comprises a central processor or CPU 20. The entertainment system also comprises a graphical processing unit or GPU 30, and RAM 40. Two or more of the CPU, GPU, and RAM may be integrated as a system on a chip (SoC). Further storage may be provided by a disk 50, either as an external or internal hard drive, or as an external solid state drive, or an internal solid state drive.

The entertainment device may transmit or receive data via one or more data ports 60, such as a USB port, Ethernet® port, Wi-Fi® port, Bluetooth® port or similar, as appropriate. It may also optionally receive data via an optical drive 70. Audio/visual outputs from the entertainment device are typically provided through one or more A/V ports 90 or one or more of the data ports 60. Where components are not integrated, they may be connected as appropriate either by a dedicated data link or via a bus 100.

Examples of a device for displaying images output by the entertainment system include a head mounted display ‘HMD’ 120 worn by a user 1, a TV (not shown), and a portable screen 140.

Interaction with the system is typically provided using one or more handheld controllers 130, 140, and/or one or more VR controllers (130A-L,R) in the case of the HMD.

The entertainment system is an example platform for the methods and techniques herein, and may be configured as a recap system. Equivalently a server-based system (for example providing a cloud based game service) may similarly be configured as a recap system to implement the methods and techniques herein. The server may comprise similar architecture to the entertainments system, either in hardware or virtualised, or a mix of the two. References herein to the entertainment device or recap system equivalently encompass a user's entertainment system or a server/cloud-based instance, unless otherwise specified.

Referring now also to FIG. 2, in embodiments of the present description the operating system of the entertainment device, or a helper application thereof, implements a so-called a universal data system service (UDS) 200 that games (210A-C) can interact with to define activities. An activity is typically a unit of game play such as a quest, or a location, or a level, or a race, the unit depending on the type of game.

To accommodate this, games are structured to comprise one or more activities (220A-C), typically operating sequentially (for example in the case of races) and/or in parallel (for example in the case of quests).

The game notifies the UDS when a particular activity has been started, and when it ends. It can also notify the UDS of progress within an activity, and if/when an activity is interrupted (e.g. because a user stops playing).

The UDS provides a common schema for defining activities and typically for defining how to notify when activities have started/ended, are when they are available, and optionally also what message to provide to the game to start or resume an activity.

In this latter case, the operating system can provide so-called activity cards; these are provided to the user via a UI, and each one signifies the start of an activity. If the user selects an activity card, the game is opened at (or changes to) the start point of the activity in the game. Where a user was previously engaged in the activity, optionally the card can be used to resume the activity in the game substantially where the player left off.

The cards use information provided by the game (or accompanying the game) for the start point of the activity, and typically also a representative image or description for the activity. Cards may be unlocked as play through the game progresses (e.g. to allow access to activities in the current part of the game, or to revisit earlier activities).

In this way, users can easily and quickly access activities within their games by accessing activity cards through the UI.

In addition to optionally providing quick access to activities via the activity card scheme, the UDS optionally enables the provision of relevant help for users, providing tips, example videos (provided by the developer, or through a user community), and other walk-throughs or tutorials that are associated with a specific activity or section of the game. Optionally an indication of progress through an activity may also be used to identify a relevant help video.

Accordingly the UDS can keep track of a user's progress through a game and optionally provide quick access to current/open/available activities and/or help for current/open/available activities.

In embodiments of the present description, the UDS system is enhanced to provide a basis for a third function: a recap system.

The UDS, or an associated helper ‘recap app’ thereof (hereafter generically ‘UDS’), records when a game notifies the UDS of an activity starting or finishing as before, and preferably any progress, waypoints, or similar indicators provided the UDS during an activity. Hence typically for a particular game title the UDS records an activity identifier and an activity status.

Notably the UDS also records the date and optionally the time that this occurs.

In this way the UDS effectively builds a journal of activities detailing a user's game progress over calendar time.

The UDS may also monitor in-game behaviour using the same system. For example if an activity is revisited multiple time before it is completed, this indicates that it was difficult for the user and hence may be a particularly good memory prompt. Similarly if the user completed an activity particularly quickly or with a particularly high score, or another metric that places the user in a high performing subset of a wider corpus, then this indicates particular success and hence similarly may be a particularly good memory prompt. In this case, the UDS can request comparison data from a server that receives metrics from a plurality of entertainment device UDSs and based on these is able to provide indicators of comparative success or failure to UDSs (e.g. threshold values for top & bottom quartile, decile, and/or centile, mean and standard deviation, and the like, for various times, scores, or other statistics of the game activities).

By monitoring in this way, the UDS can estimate activities in the journal that may have personal interest for the user.

Similarly, the operating system or a helper app thereof can maintain a trophy system for a game. Most games have trophies, which recognise certain achievements within the game that may be singular (e.g. the result of a one-off event such as reaching a particular location) or cumulative (e.g. after rescuing 100 people). Hence some singular trophies may be linked to certain activities; optionally the UDS receives notification of these as well and similarly logs the date and incorporates them in the journal. Optionally some cumulative trophies may also be logged, and/or logged and marked as cumulative trophies—these tend to have less correlation with the plot of a game, but may be memorable to the user in a similar manner to other indicators of success mentioned previously.

Separately, it is desirable to identify activities, or moments within the activities, that are important to recalling the plot of the game, so that the user can quickly become re-invested in the game's story and protagonist(s). The plot, as such, may relate to a storyline of the game, mere progress within the game, and/or significant events or achievements within the game, depending in part on how narratively driven the game is. Hence references to ‘plot’ herein can optionally encompass progress, significant events, and/or achievements.

In a first instance, these may be provided by game developers (or publishers) where they choose to take advantage of the recap system and methods described herein. Hence for example game developers can add metadata to activity notifications indicating which activities or moments therein are key to the plot; more specifically they can add metadata indicating whether the start of an activity is key to the plot, and/or the end of the activity, and/or optionally a particular point of progress within the activity. More specifically still, where appropriate they can add metadata indicating which point or ending of an activity is important to the plot, if only one of several possible points or endings is relevant.

Similarly, as noted above game developers can add metadata indicating interim points in an activity that are important to a plot (since these may not necessarily be at the start or end of an activity).

Similarly, game developers can add metadata to trophies indicting whether they correspond to an event important to the plot. Optionally they can add trophies specifically to mark progress in the game that corresponds to such key plot points. Further optionally they could add ‘hidden’ trophies to exploit this process, with such hidden trophies optionally not counting toward a conventional trophy list, total, score, or completion goal.

It is also notable that help videos for the UDS system can be tagged; for example videos that are for finding collectibles are marked as such. Hence help videos could also be tagged for relevance to the plot, and this could be cross-referenced with the associated activity/event.

Hence more generally the UDS system can log events (activity starts, ends, and optionally interim points, and trophies, typically for singular events) together with the date and optionally the time they occurred, and also optionally together with metadata indicating their relative level of importance to a recall of the plot (or more generally to recall of the game so far, since not all memorable points may relate specifically to plot per se).

Alternatively or in addition to developer/publisher provided metadata, it is possible to automatically estimate when activities/events in a game are important to the plot. Hence it is possible for the UDS to generate a similarly augmented journal even when a developer does not provide such metadata, or only a sparse amount.

Indicators of plot points within a game include:
The start and/or end of an activity. Optionally in particular for an activity upon which one or more activities later depend or have a conditional requirement (e.g. Can't access the mountains in the game until a particular quest is completed—that quest is then likely to be important to the plot).
Singular trophies per se, optionally prioritised based on rarity with which they are awarded.
The use of a pre-rendered cut-scene, or an in-game animated cut-scene, optionally prioritised by proximity in time to the start or end of an activity or to a trophy; such cut scenes generally provide exposition and/or scripted events that the developer considered important to the plot and therefor uninterruptable/unalterable by the player.
Similarly, any part of a game with a normally free field of view where the camera view is temporarily placed on a scripted path—this typically relates to showing a key moment or detail, even if the game is otherwise still interactive.
Any dialogue that is more than a predetermined length, and/or is found at the end of multiple dialogue trees, or at the end of a dialogue tree with no branches (i.e. is important to be said regardless of user action), or a point in a dialog tree that is flagged as being a necessary condition for progress in one or more activities.
In a similar manner, parts of an activity associated with multiple saves, pauses, or accesses to in game resources (e.g. potions, healing etc.), or system resources (e.g. a help guide), which indicate a point in the game where the player struggled (i.e. a player-centric plot-point/memorable moment as opposed to a game-driven plot point).
Again in a similar manner, parts of an activity associated with particular success relative to a wider corpus of players, as described elsewhere herein (again, a player-centric plot-point/memorable moment).

The UDS may identify one or more of the above, or any other suitable indicators (for example if the game auto saves, this may indicate the next part is of some relevance to game progress). Furthermore where two or more such indicators substantially coincide in time (for example the game is saved, starts a new activity, and triggers a cut-scene) then this can be taken as indicative of a relatively higher priority/likelihood indication of an element of the game important to the plot. Hence the relevance of an in-game event, and optionally its relative importance to the plot, may be estimated based upon the detection and/or analysis of one or more indicators of plot points within the game.

Hence in any event, the UDS system can build a journal of game progress based on the existing UDS activity scheme, optionally augmented with metadata from developers/publishers indicating important plot points, and/or augmented with estimations of important plot points based on one or more indicators of plot points within a game.

Notably, this represents very little additional overhead for the entertainment device as the UDS system is already operating; the addition of date information, and optionally plot relevance information, is cheap in terms of computational and storage overhead.

This is advantageous particularly when games may have (or are estimated to have) complex plots, and where the user has a library of potentially a hundred or more games.

Having compiled a journal for a game, in embodiments of the present description the UDS is then in a position to generate a recap for a user.

### Recap Content

Notably, whilst the UDS has compiled a journal, it has not specifically stored any extra information that could be used to provide the recap itself. A typical recap in a television show includes video of key moments in previous episodes, and possible text summarising plot points or providing context for the video clips. The UDS does not create or store these in response to the creating of journal entries.

Advantageously this avoids the entertainment device needing to speculatively store large amounts of video for multiple games, just in case the user needs a recap of a game in the future, which would be necessary otherwise. This would be a significant waste of finite storage resources.

Instead, in embodiments of the present description, the UDS can take advantage of its existing functionality for providing relevant help to users.

The UDS system enables the association of activities with help videos that can be accessed from remote sources (e.g. a server administered by the operator of the UDS system, a game developer/publisher, and/or a gaming community). A help video can be associated with an activity ID and optionally a progress or key point indicator where this is also reportable to the UDS scheme. When a user needs help, the UDS system can request a help video from one or more remote sources using the relevant current activity ID and any further activity indicators provided to the UDS system. Because these are standardised, the relevant video—if it exists—can easily be found. Conversely if such a video does not exist this is also easy to identify and remedy, for example by community members uploading a home-made help video vide the UDS system with the associated ID and optional further indicator information.

As a result there is a rich source of video of the game available to the UDS—whilst the available video is not specific to the current user of the entertainment device (i.e. not a recording of their own game play), it will be sufficiently similar to act as an aide memoire within a recap of the game. Indeed, for some parts of some games, such as cut-scene and scripted animations, it may to all intents and purposes appear identical.

Consequently, for journal entries selected for inclusion in a recap, the UDS system can request a help video corresponding to that activity/moment. Since points that are important to a game's plot are typically also important to game progress, these tend to be well covered within the existing help system. However as noted above, this can be augmented and/or substituted with community help videos as well.

If developers choose to implement the techniques herein to create recaps, then optionally activity notifications to the UDS system, and/or metadata for help videos, can include recap text; text intended to provide plot/narrative/progress context, either by itself as text for the user in the recap, and/or for a video, e.g. as an introduction or overlay. Alternatively or in addition, the title associated with a help video may be used for context.

Hence in an example, a user may have played a game in which the protagonist is shown waking up with amnesia in a cut-scene, before the player eventually finds a weapon, beats a guardian, and finds a friend. The recap may then comprise the cut-scene, which may be stored locally as part of the game, and streamed or temporarily downloaded help videos relating to finding the weapon, beating the guardian, and finding the friend.

Optionally, the game can then start so that the user can play immediately from their last saved point. Optionally, the game can load in the background whilst the recap is playing.

It will be appreciated that another reason for needing a recap may be if the user chooses to load an old save game; for example a user may choose to save a game before a critical branch in the story (whether they realise that at the time or not), and then (possibly much) later choose to revisit that old point. Hence optionally rather than generating a recap relative to the current/most recent progress within the game, a recap may be generated relative to the progress within the game indicated by whichever game save has been selected for loading—whether still a current ‘continue game’ automatic save, or an older automatic or manual save.

Hence more generally the UDS system sources content associated with activities or moments/progress therein relevant to a recap of the plot, the content typically being pre-recorded video included in the game, or pre-recorded video supplied from a separate source in response to a help system, rather than video of the actual user recorded to the local entertainment device during game play. As noted elsewhere herein, such a recap scheme would not be feasible if the entertainment device had to speculatively record video to local storage for various plot points of a plurality of games, as it would waste a large amount of storage that could otherwise be used for other games and applications. It will be appreciated that this also applies for example to a cloud streaming service implementation of the game (as mentioned elsewhere herein), where similarly it would not be feasible if it otherwise required server storage of game progress video for many different users. Hence more generally references herein to an entertainment device also encompass real and virtualised instance of such entertainment devices in a cloud streaming service.

### Recap Compilation—Content and Length

As a preliminary optional step to generating a recap, the UDS can estimate how long it is since the user has played the game. This may be separately recorded, or otherwise may be estimated by comparing the current date (and optionally time) with that of the most recent journal entry (or optionally the most recent journal entry identified or estimated as important to the plot) or similarly the most recent save game.

It will be appreciated that a user who has been away from a game for longer may benefit from a more complete reminder of the game's plot points/key moments. Hence the length of a recap may be responsive to how long the user has been away from the game.

It will also be appreciated that many games may comprise 10, 50, or 100 hours of content, and so a more complete reminder may still need to be limited to a palatable length for the user. That length may be predetermined, or may be user selectable (e.g. in a system menu); for example stating that recaps should be no more than 30 seconds, 1, 2, 3, 4, or 5 minutes. Optionally different time limits can be provided for different scenarios: as a non-limiting example, 30 seconds if last played in under a week, two minutes if played in under a month, and 4 minutes if not played for over a month. Further alternatively, the user may be offered the choice of a short, medium, or long recap. In the above example, ‘played’ may exclude instances where the user opened the game but did not load/resume game play, or only played for less than a threshold time (e.g. a few minutes) or didn't progress any further—since these behaviours may actually be indicative that a recap is needed.

Hence the compilation of a recap may consider two aspects; how much to include in the recap, and how long the recap should be. It will be appreciated that quite often these two aspects may be in conflict.

In any event, it is therefore likely that not all preceding events (or even all those identified as important to the plot), would be included in every recap. Therefore one or more methods of selection are needed to take account of one or both of the above aspects.

### Content—What to Include

In a first instance, a recap could include media related to all journal entries for the game within the UDS—however this would be likely to last a long time, possibly being a near-complete re-enactment of the game. Generally this may be considered undesirable.

In a second instance, a recap could include media related to all journal entries for the game within the UDS that have been identified or estimated as important—however, whilst this is likely to be more relevant, there is no real control over how long the recap would be as it may depend on the extent of progress through the game to date, nor is there any control over the relative value of the plot points to the current game state.

In a third instance, the recap could include media related to journal entries for the game within the UDS, but with a minimum spacing imposed between them so that entries whose journal date/time/position fall within the spaces are not included in the recap; in this case, the minimum spacing could increase linearly or non-linearly backwards from the most recent entries. Optionally, working backwards the next journal entry identified as important could be selected and define the next spacing, thereby generating an increasingly sparse selection of journal entries. This would result in a recap that increasingly focussed on recent events within the game, whilst also giving some broader context from earlier on in the game. In this case optionally a journal entry could override exclusion if it was deemed sufficiently important or had a sufficiently high indicated priority.

Equivalently to the above, only one journal entry might be chosen from within a spacing. Again the spacing could increase linearly or non-linearly backwards from the most recent entries. In this case, the highest importance/priority journal entry falling within a given spacing could be chosen. Again optionally a journal entry could override exclusion if it was deemed sufficiently important or had a sufficiently high indicated priority.

Hence increasing selectivity of journal entries, as a function of how far back in the game they were relative to a given point (e.g. that of a game state to be loaded), can be achieved either by an exclusionary or inclusionary use of variable spacing.

It will also be appreciated that the rate of increase of spacing will affect the number of entries that are selected, and so potentially the length of the resulting recap. Alternatively or in addition, including an optionally adjusting a threshold for the relative importance/priority of entries will similarly affect the number of entries that are selected, and so potentially the length of the resulting recap.

Hence by adjusting one or more selection metrics such as journal entry selection spacing and threshold journal entry importance thresholds, the number of journal entries within a recap can be adjusted, for example to meet or be under a target number, whilst preserving recap content relevant to the state of the game that the user is about to play.

However, even the above does not fully control the length of the recap, because the journal entries themselves do not define the length of videos associated with them (or with help for them).

Hence one set of five journal entries could cause the access/retrieval of a total of five minutes of video, whilst a different set of five journal entries could cause the access/retrieval of a total of two minutes of video.

Hence optionally further control is needed.

### Content—Timing

In a first instance, the length of videos that would be accessed/retrieved in response to candidate journal entries can be obtained as a preceding step to actually accessing or retrieving (e.g. streaming) them; in this way the length of a candidate recap can be assessed. If it exceeds a threshold length, one or more of the above selection metrics may be adjusted to reduce the total number of candidate journal entries, and with it the total duration of the recap.

This in turn may be subject to improvement, as it sacrifices entries without information about the relevance of the videos to the plot across their full length; in other words, it is a trade-off based on incomplete knowledge of what a good trade off would be.

To address this, optionally a minimum number of entries may be required in a recap (assuming there are at least that many candidate entries—if not then likely all entries are considered).

Where the minimum number of entries and the maximum duration of recap are in direct conflict (i.e. having adjusted selection metrics to select the minimum number of entries, it still results in a recap that is too long) then optionally the UDS can identify the additional entries to remove to get under but close to the maximum duration.

Hence for example consider a recap lasting 3 minutes and 36 seconds, whilst and the maximum allowed duration was 3 minutes. In the recap are the two longest entries at 45 seconds and 30 seconds, and the two shortest at 10 seconds and 5 seconds.

Deleting the 45-second entry would result in a recap of 2 minutes and 51 seconds.

Deleting both the 30- and 10-second entries would result in a recap of 2 minutes and 56 seconds.

Deleting both the 30- and 5-second entries would result in a recap of 3 minutes and 1 second, and so is not a candidate combination for removal.

Choosing whether to delete the 45-second entry or both the 30 and 10 second entries may be evaluated in several ways. If may be assumed that all remaining entries are important to the plot, and so removing the fewest is the better option. Alternatively each entry may have a relative importance, and so removing the entry or entries with the lowest (combined) importance is the better option. Further optionally where the help videos themselves have tags indicating their relevance to the plot, this can be used as part of the importance evaluation. Further optionally for either of these approaches a weighting may be given to favour deletion of older entries in the recap (for example weighting their relative importance as a function of age of the journal entry).

However, again these techniques are hostage to the actual length of the associated videos; if one video is particularly long it could crowd out a lot of the potential recap in a time-limited implementation. The shorter the desired recap, the more acute this becomes.

Consequently, alternatively or in addition, the techniques herein can further exploit the fact that they re-purpose existing help videos: the UDS can request that a help video is not streamed from the start but form a predetermined point prior to the end; it will be appreciated that most help videos are goal-oriented, and so the relevant goal/event/outcome can be reasonably assumed to occur close to the end of each video (since no further help is needed afterward). Hence the UDS in effect can truncate help videos, retaining only an end portion, and still be likely to obtain footage that is relevant to the recall of the plot. This approach can be used when there are particular constraints on overall recap time (e.g. selectively truncating the longest videos first until the overall recap time is reached), and/or in response to an individual help video exceeding a predetermined length, and/or responsive to the relative age of the associated journal entry (i.e. tending to truncate events from earlier in the game), or as a blanket policy, itself optionally only triggered in response to separate and more lenient content count and/or duration thresholds.

Finally, it will be appreciated that the helper videos and the associated activities are generally provided with an informative thumbnail/summary image, and often also a description. The image and/or the description (or supplementary text provided as metadata with an event by the developer) may be used alternatively or in addition to the video. If used instead, it can potentially provide a quick recap by being shown, for example, for 3, 5, or 10 seconds. Optionally such text and images could be used for older events to retain them in the recap in a time-efficient manner. A threshold for when to switch from text/images to videos could be employed, which may vary based on the target period of the whole recap and optionally the number and distribution of candidate events within the recap in either side of such a threshold. Hence for example where a minimum number of events in a recap is in conflict with a maximum recap duration, optionally the oldest events in turn may be represented by text/static images until the overall recap duration falls with the maximum.

The above trade-offs can be combined in any suitable manner to generate a recap that includes optionally a minimum amount of context (journal entries) and/or optionally fits within a maximum amount of time. In addition to being used when fitting one or both of these constraints, optionally, any of these trade-offs may be used for other editorial reasons independent of whether these constraints are imposed or come into effect, for example to manage the flow of information by ensuring no single video is significantly longer than another, or ensuring more clips relating to recent events are included, for example.

Hence as a summary approach, the UDS can work backwards from the time corresponding to the loaded game state to gather candidate content and then selectively retain/drop candidate content according to one or more pattern criteria (e.g. fewer items of older content based on linear or non-linear spacing) and one or more content criteria (e.g. minimum numbers of content items, and/or maximum recap durations), optionally editing content (e.g. truncating help videos to retain the latter parts of them) either in response to individual content criteria (e.g. a threshold maximum length for individual videos) or recap criteria (e.g. a maximum recap duration).

The recap can also include other useful information. As noted elsewhere herein, it can include text to provide further contextual information (and optionally such text may have an associated reading time provided or calculated for it, as part of the overall recap time). However optionally the recap can include a reminder of the controls for the user—for example including (e.g. ending with) a graphical display of a controller and what the relevant inputs do in the game.

The recap could also include a reminder of what friends, groups, and/or so-called clans the user has played with (or indeed against), in case they want to revisit them, for example in the case of multiplayer games. The recap could also include a reminder of what levels, mods, game modes, or options the user used to most frequently choose, based on data recorded during earlier plays of the game.

It will be appreciated that the methods and techniques herein advantageously generate content for a user that is relevant to their in-game progress, whilst avoiding computational and memory overhead when compiling the event journal, and notably avoiding computation and storage overhead by avoiding recording video of the user's own progress through the game; instead it reconfigures an existing mechanism to select existing help videos to compile the recap.

The computation and storage overhead may be further reduced when generating the recap video by not first downloading/acquiring the helper videos; instead, generation of the recap video can comprise scheduled request of all or part of a helper video to be streamed to the entertainment device (or more generally the user's client device), so that the recap video subsequently comprises a streamed sequence of multiple helper videos or parts thereof, optionally together with cut-scene video or parts thereof, and any of the other possible content described herein. Hence the generated recap video may in practice more closely resemble an edit sequence referencing one or more help videos and optionally existing pre-recorded local video content, and optionally the other possible content described herein. It is then created ‘live’ or in real time when it is being watched by the user.

### Summary

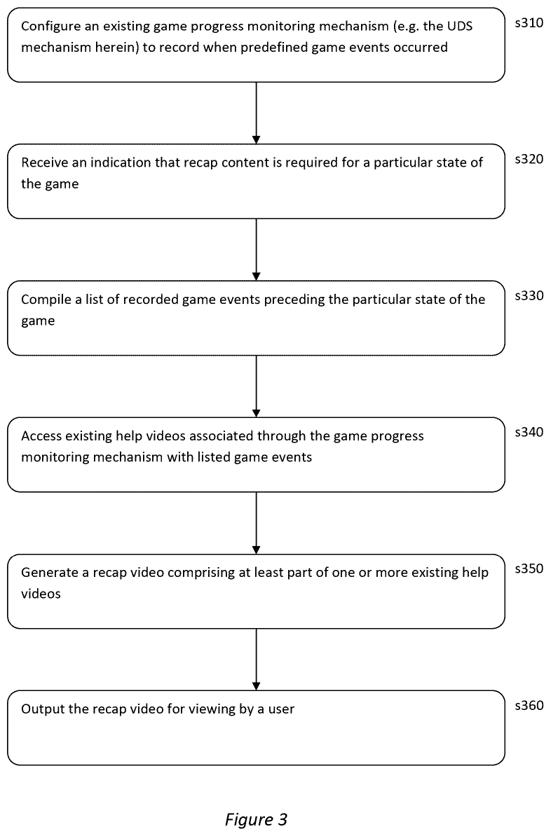

Turning now to FIG. 3, in a summary embodiment of the present description, a method of content generation for recapping a game (or equivalently other interactive content) comprises the following steps.

In a first step s310, configuring an existing game progress monitoring mechanism (e.g. the UDS mechanism herein) to record when predefined game events occur (e.g. activities, their starts, ends, key moments, etc.), as described elsewhere herein.

In a second step s320, receiving an indication that recap content is required for a particular state of the game (e.g. when a threshold period of time has elapsed between game plays, or due to a user setting, or due to a current user input), as described elsewhere herein.

In a third step s330, compiling a list of recorded game events preceding the particular state of the game (e.g. the state of the game as the user is about to play it), as described elsewhere herein;

In a fourth step s340, accessing existing help videos associated through the game progress monitoring mechanism with listed game events (e.g. developer and/or community help videos available through the existing help/activity scheme supported by the UDS), as described elsewhere herein.

In a fifth step s350, generating a recap video comprising at least part of one or more existing help videos (e.g. as an actual video and/or as an edit sequence for real-time construction), as described elsewhere herein.

And in a sixth step s360, outputting the recap video for viewing by a user (e.g. outputting to a TV, HMD, or integral display, as appropriate), as described elsewhere herein.

It will be apparent to a person skilled in the art that variations in the above method corresponding to operation of the various embodiments of the apparatus as described and claimed herein are considered within the scope of the present invention, including but not limited to that:
the particular state of the game relates to when a loaded save game was created (e.g. a most recent ‘continue play’ save game, or an older, user-selected save game), as described elsewhere herein;
the step of compiling a list of recorded game events comprises selecting (e.g. a subset of) game events responsive to an indication of event importance, as described elsewhere herein;
   in this case, optionally an indication of importance is obtained from metadata associated with the event report to the existing game progress monitoring mechanism, as described elsewhere herein;
   similarly in this case, alternatively or in addition an indication of importance is obtained from an analysis of the game state and event report, including one or more selected from the list consisting of whether the event relates to the start or end of a predefined activity, whether the event is associated with the award of a trophy, whether the event substantially coincides with the use of pre-recorded content within the game, whether the event substantially coincides with the use of scripted in-game animation or camera control, whether the event is associated with a particular point in a dialog tree, whether the event substantially coincides with user activity indicative of difficulty progressing in the game, and whether the event substantially coincides with user success relative to a wider corpus of players, as described elsewhere herein;
the step of compiling a list of recorded game events comprises selecting game events responsive to a minimum event separation criterion (e.g. inclusionary or exclusionary), wherein the minimum increases (e.g. linearly or non-linearly) the further back in time the event is from the particular state of the game, as described elsewhere herein;
events are recorded in response to notifications using an existing universal data system service (e.g. the UDS), as described elsewhere herein;
in this instance, optionally events are also recorded in response to one or more selected from the list consisting of notifications using an existing trophy service, and notifications based on an analysis of user interactions with the game, as described elsewhere herein;
the step of generating a recap video comprises including (e.g. directly or as an access/streaming request in a sequence) one or more selected from the list consisting of an existing pre-recorded cut-scene of the game, supplementary text associated with a listed event, supplementary imagery associated with a listed event, information about the controls associated with the game, information about other players or player groups the user has previously interacted with, and information about game preferences the user has previously shown, as described elsewhere herein;
the step of generating a recap video comprises calculating a target length of the recap video responsive to one or more criteria selected from the list consisting of how many events have been recorded by the existing game progress monitoring mechanism how long it has been since the user last played the game, and a duration selection by the user, as described elsewhere herein;
the step of generating a recap video comprises, where the duration of a recap video will exceed a target duration, adjusting the recap video by one or more selected from the list consisting of reducing the number of events in the list, subject to any minimum number, truncating one or more helper videos to retain only a shorter, latter part thereof (either directly or by use of stream start point commands in a streaming request), and using a static image associated with a helper video instead of the helper video, as described elsewhere herein;
the method comprises the steps of receiving an indication that a tutorial is required for a particular state of the game, determining a purpose of the tutorial based at least in part upon records from the game progress monitoring mechanism, selecting one or more existing content elements related to the game, based at least in part upon the determined purpose of the tutorial, generating the tutorial based upon the one or more selected existing content elements; and providing the tutorial to the user, as described elsewhere herein; and
   in this case, optionally the step of providing the tutorial to the user and the step of outputting the recap video for viewing by the user are combined, as described elsewhere herein.

It will be appreciated that the above methods may be carried out on hardware suitably adapted as applicable by software instruction or by the inclusion or substitution of dedicated hardware. Thus the required adaptation to existing parts of an equivalent device may be implemented in the form of a computer program product comprising processor implementable instructions stored on a non-transitory machine-readable medium such as a floppy disk, optical disk, hard disk, solid state disk, PROM, RAM, flash memory or any combination of these or other storage media, or realised in hardware as an ASIC (application specific integrated circuit) or an FPGA (field programmable gate array) or other configurable circuit suitable to use in adapting the conventional equivalent device. Separately, such a computer program may be transmitted via data signals on a network such as an Ethernet, a wireless network, the Internet, or any combination of these or other networks.

Accordingly, in a summary of the present description, an entertainment device 10 (either local to the user, or as part of a cloud gaming service), for generating content that recaps a game, comprises the following.

An existing game progress monitoring mechanism (e.g. the UDS of the OS, running for example on CPU 20), configured (e.g. by suitable software instruction) to record when predefined game events occur, as described elsewhere herein.

A processor (e.g. CPU 20) configured (e.g. by suitable software instruction) to receive an indication that recap content is required for a particular state of the game (e.g. when a threshold period of time has elapsed between game plays, or due to a user setting, or due to a current user input), as described elsewhere herein.

A compilation processor (e.g. CPU 20) configured (e.g. by suitable software instruction) to compile a list of recorded game events preceding the particular state of the game (e.g. the state of the game as the user is about to play it), as described elsewhere herein.

A receiver (e.g. data port 60, optionally in conjunction with CPU 20) configured (e.g. by suitable software instruction) to access existing help videos associated through the game progress monitoring mechanism with listed game events, as described elsewhere herein.

A video processor (e.g. GPU 30, CPU 20, or a combination of the two) configured (e.g. by suitable software instruction) to generate a recap video (e.g. as an actual video and/or as an edit sequence for real-time construction) comprising at least part of one or more existing help videos, as described elsewhere herein.

And the video processor is also configured (e.g. by suitable software instruction) to output (e.g. to a TV, HMD, or integral display, as appropriate) the recap video for viewing by a user.

Instances of this summary embodiment implementing the methods and techniques described herein (for example by use of suitable software instruction) are envisaged within the scope of the application, including but not limited to that:
the compilation processor is configured (e.g. by suitable software instruction) to select (e.g. a subset of) game events responsive to an indication of event importance.

### Tutorials

The preceding description focussed on generating content that reminds a user why they are playing the game; however, alternatively or in addition it may be useful to remind a user how to play the game.

The recap mentioned previously may optionally include a reminder about the game controls, which may be thought of as a universal or unconditional reminder appropriate to any player, but more tailored and effective reminders are possible.

Again in principle the developers of the game can provide tailored reminders in game, but for legacy games, and for games where no or minimal tailoring is provided, then alternatively or in addition an automated system may be considered.

The basic mechanisms are similar to those described previously in relation to generating recaps. Hence activities and optionally moments therein can be relevant to the plot, but more widely can be relevant to game or quest progress.

Consequently based on such progress, the activity log of the UDS system can be used to estimate one or more of the following factors that may be relevant to a tutorial:
i. what the user was doing, or needed to do, in the game as last played;
ii. the user's play style, skill selection, character class, or the like; and
iii. why the user stopped playing the game.

### What to do

Again as noted with respect to plot, the UDS can log an activity upon which one or more activities later depend or have a conditional requirement (e.g. can't access the mountains in the game until a particular quest is completed—that quest is then likely to be important to the plot).

Conversely, if a user was last at the mountain pass but was unable to progress further, then those same dependencies can be used to identify the activity or activities necessary to be completed in order to progress further.

Similarly, as noted with respect to plot, remotely held help data is associated with activities (and optionally trophies as well), and accessible via the UDS system. Accordingly help data associated with a current goal of the activity can be used to identify what is needed to be done.

Optionally, if developers choose to implement the techniques herein, then as well as optionally providing plot metadata with at least some activities, they can provide goal/tutorial metadata with at least some activities, for use via the UDS.

### Play Style

Without bespoke access to the game state, the user's approach to play of the game may nonetheless be inferred from various sources.

Firstly, some trophies may be specific to certain character classes or activities (for example a person who has several game trophies associated with killing enemies, but none associated with collecting objects, is likely to play the game in a different way to a person with the opposite combination of trophies).

Secondly, some activities or activity outcomes may be either specific to a certain character class or approach to a game; hence whether the activity has been started, whether they then have been completed, and how soon after they became available they were selected, can all be indicators of a player's preference for that type of activity. Similarly some quests and/or locations may be character, skill, or play style specific, and are typically reflected within specific activities.

It will be appreciated that the analysis of trophies or activities need not be limited to the particular game for which a tutorial is being considered—users tend to have a consistent playstyle and preferences, and so information from other games (though preferably within a similar genre to the current game) may be informative.

Again optionally, if developers choose to implement the techniques herein, then as well as optionally providing plot metadata with at least some activities, they can provide goal/tutorial metadata with at least some activities, for use via the UDS. Indeed the selection of a respective character class could be set up as a respective activity, for example, providing a simple means to embed this information within the UDS journal of entries.

In this case, where a different game has had metadata provided in accordance with the techniques herein, but the present game for which a tutorial is being considered has not, the information available to the UDS for the enhanced game may be used to fill in unknowns for the present game or to resolve ambiguities in the available information.

### Why Stopped

A user may stop playing a game for a number of reasons, and again some of these may be discerned from UDS information, and optionally other sources within the entertainment device.

The simplest reason is because the user has been away. In this case it is likely that in addition to the current game for which a tutorial is being considered, any other games on the entertainment device have not been played either. This can be detected from their respective UDS journals, and/or access dates of load/save files (or how long since the entertainment device was powered on, although other players may still use the device and play the games on their own accounts). In this case it may then be assumed that the user did not have a specific reason for stopping game play.

Another common reason is that a new game has been launched. For certain game genres in particular (e.g. multiplayer games) it is common to start playing the game soon after launch as this is when the concurrent player base is likely to be largest, and the game engagement and updates most frequent. Hence a user may interrupt play of the current game to play a new game for a while. Optionally the relative newness of the game can be checked as a further indicator that this is the user's motive. In this case it may then be assumed that the user did not have a specific problematic reason for stopping play.

A similar reason is if the user switches to a game that they then play with other users included on a friends list—in this case it is likely that they have switched games for social reasons rather than because of anything to go with the original game itself. Hence again in this case it may be assumed that the user did not have a specific problematic reason for stopping play.

Conversely if the player switches to an old game, or a game that they played previously, it may indicate that they are bored with the current game.

Another common reason is that the user largely completed the original game, and is now returning to it because there they are accessing downloadable content (e.g., an update, patch, and/or expansion). In this case, the addition of the new content can be detected. Consequently, it can be assumed that the user enjoys the game, wants to play more of it, and does not have a specific or negative issue with playing it.

Another common reason is, in effect, the opposite of this; they got stuck and so did not complete the game. This can be detected for example from the UDS journal ending with multiple attempts to finish an activity, and/or multiple saves/loads occurring within the last activity in the UDS journal, both of which are indictors of multiple failed attempts to proceed further within a game.

The above reasons can be thus be placed on an approximate spectrum from mostly negative to mostly positive:

| | | |
|---|---|---|
| Very Negative | - | Unable to progress |
| Negative | - | Bored |
| Slightly Negative | - | Tempted away |
| Neutral | - | Simply away |
| Positive | - | Awaiting new content |

These different reasons can lead to different tutorials, optionally further tailored to respective playstyles and/or activities.

### Arranging a Tutorial in Response to Factors

In the case of positive, neutral, and slightly negative indicators of why a user stopped playing, optionally it can be assumed that there is no a specific problem to address and so a generic tutorial or how-to reminder may be provided simply to allow the user to regain muscle-memory prior to starting any in-game action of consequence.

This may be achieved by starting an existing in-game tutorial, but this may be seen as too easy or too backward a step for generally happy and engaged players of the game. Hence optionally the tutorial may be instructed to use the player's currently available character/skillset/inventory etc., rather than any defaults used when the tutorial was first encountered in the game. Similarly any adaptive difficulty system may be used, so that any enemies in the tutorial are for example harder to kill or deal greater damage. In this way, the tutorial can be adapted to the user's current play style or skill set.

This may require the game to follow at least this aspect of the techniques described herein, for example monitoring an API the provides tutorial request and optionally configuration instructions such as the use of the current player state as found in the save file that the player intends or is likely to use.

Meanwhile, where for example a specific tutorial level does not exist (for example because the game is crafted to have a learning curve during game play), or if it is not adaptable, or in some other manner not appropriate, then several alternatives exist.

The UDS system may support an accessibility tag or similar for specifying whether there is a sandbox mode in the game. Such a sandbox mode can allow players—particularly those with disabilities—to experiment with controls and control configurations without affecting the main game. This scheme may typically use a particular area of the game, but is not a tutorial per se.

Optionally the UDS system can create a sandbox mode for a game that does not support such a thing, by preventing the game from saving its status in a persistent record; consequently any actions in this sandbox mode are not permanent and will not be remembered in the game when the game proper is continued, or a saved game is loaded.

Accordingly, optionally such sandbox modes may be used, in conjunction with an activity card corresponding to an activity in the UDS journal. Typically, for a person who has a positive, neutral, or only slightly negative reason of not recently playing the game, this could be the last activity the user was engaged in. Meanwhile for players with more negative reasons, the last activity may be a counter-productive choice as it may be why the user stopped playing.

Optionally, if the last activity indicates a boss battle (for example due to indicative metadata or an associated trophy), then a preceding activity may be selected, as a boss may be a particularly difficult activity to start with.

Alternatively or in addition, an activity card associated with gaining a key skill could be used. In the case where a developer implements aspects of the present techniques, an activity can comprise metadata indicating that it introduces a new skill. Alternatively, a trophy recognising the acquisition of a new skill may be associated with an activity, or the activity that was open when the trophy was awarded may be detected from the trophy data and the UDS journal.

The key skill may be for example the most recently acquired key skill in the game. This will be likely to act as a good reminder to the user of how to play, and typically will be acquired as a prelude to any more challenging activity such as defeating a boss—that is likely to happen after familiarity with the new skill has been gained.

Another mechanism for choosing a representative activity to include in a sandbox is to request a recommendation from a server that has access to data from a cohort (corpus) of players. For example the server can determine the most common/popular activity within the cohort from among the last N activities in the user's UDS journal. Alternatively or in addition the server can determine the activity that has triggered the fewest UDS help requests from among the last N activities in the user's UDS journal, as being indicative that it would assist rather than confuse a returning player. Alternatively or in addition the server can determine the activity that has the highest percentage of users in a cohort achieving an associated trophy, again being indicative that it would assist rather than confuse a returning player.

With one or more of the above techniques, a tutorial level (whether original, modified, or a proxy based on a sandboxed activity) can be selected that is likely to be a positive reminder of game play for a user, in particular for users that may be estimated to have a positive, neutral or only slightly negative reason for not recently playing the game.

It will be appreciated that the above approaches provide an automatic method of accessing or generating appropriate tutorials. However optionally the user can be asked first if they want a tutorial based on the proposed content, so that if in fact they would rather proceed directly to the game, they can. Similarly, where several possible activities may qualify as tutorials, the user can be invited to select which (or how many) they want formulated as a tutorial.

The above approaches may also be used for users that may be estimated to have a negative or very negative reason for not recently playing the game; in particular selecting popular activities with the wider cohort or activities that confer skills or trophies, that the user has previously encountered, may provide a positive reminder for these users.

Alternatively or in addition, in particular for users that may be estimated to have been stuck in the game, a further tailoring of a tutorial may be possible.

The last incomplete activity in their UDS journal—or a recent, incomplete activity that overlaps with multiple load/save events—is likely to be one that the user considered problematic.

The user can be asked for confirmation of this, or more generally—as described above—to identify which of several candidate activities (shortlisted based on the above considerations) they would like a tutorial on, if any.

In this case, the activity is assumed to be problematic for the user, and so simply presenting it to the user again is unlikely to be helpful.

Accordingly, the sandbox mode may be used with any suitable available modifications, such as one or more from the list consisting of:
i. altering a difficulty setting to an easier/the easiest available setting;
ii. reducing hit damage from enemies;
iii. increasing hit damage of the user;
iv. turning on accessibility features such as targeting assistance, path indicators, or the like; and
v. turning on hint features.

These can help the user to practice the activity in less challenging circumstances, so that they can later try to complete it in-game.

In addition, where the developer chooses to implement at least some aspect of the techniques described herein, they may include activity metadata about what skills an activity requires (and optionally what proficiency), and what skills an activity introduces, provides, hones, or the like.

Accordingly, if it appears that a user has become stuck on an activity, the UDS can look at what skills it requires, or requires proficiency in, and then look for what other activities introduce or hone those skills, to provide a more complete training programme that may comprise several activities or parts thereof, for example (re-)introducing the skill the user, optionally giving them the chance to hone that skill, and then practice it in the problematic activity.

In this way, a targeted tutorial or training programme can be generated from data in the UDS, optionally together with meta data from developers, and/or circumstantial data such as save/load behaviour associated with activities to help identify problematic ones.

All the above tutorials relate to actual interactive game play. However, alternatively or in addition, the above principles used in relation to selecting activities may similarly be applied to selecting help videos associated with those activities, to create relevant non-interactive tutorials.

Optionally, since such tutorials comprise streamed video, they could be could be provided to/accessed by a user's phone, for example using an app that allowed them to access the system with the same ID as on the entertainment device. This would allow them to review the tutorial at any time in advance of returning to the game, or indeed allow them to look at the tutorial on their phone whilst playing the game in parallel.

This latter option may also be provided on the entertainment device, for example by using a picture-in-picture approach, or scaling the game display down to provide a side bar for such a video and any ancillary information. This latter approach reduces the chances of the tutorial video obscuring parts of the game.

In addition to interactive activities, and associated helper videos, optionally text may also be provided. The developer may choose to provide explanatory text or relevant hints and tips with an activity or helper video, and these may be displayed to the user. Similarly, in some games, persistent in-game messages may be left by users. These typically provide hints and tips that users felt would be helpful. Typically these have an associated rating system (e.g. other players can vote messages up or down). Accordingly, user messages with high ratings that are associated with an activity may also be obtained from the server and displayed to the user.

Hence more generally the system can use the UDS to generate interactive or non-interactive tutorials (of a combination of the two) based on activities that may be selected according to criteria that are responsive to an estimated reason for the user taking a break from the game.

This could include the last completed activity, the last still open activity, or a recent activity, or one introducing and/or honing a key skill relevant to the last open activity.

### Other Factors

The tutorial may optionally be adjusted in response to one or more other factors.

One is how long it has been since the user last played the game. The longer the period, the more atrophied the user's muscle memory may be, and the more skills it may be appropriate to revisit.

Accordingly optionally a tutorial may not be provided or offered if a user has played the game within a first threshold period (for example one week). Between that first threshold period and a second threshold period (e.g. one month) a ‘standard’ tutorial such as described above may be offered. Beyond the second threshold, an ‘extended’ tutorial comprising several activities, or addressing several skills, may be offered.

Similarly, when a user has been playing other games since last playing the game at issue, the genre of the other game(s) may be referenced; if they are different to the present game then optionally a weighting towards a more complete tutorial may be provided (for example by reducing the threshold periods mentions above by a proportionate amount).

Again similarly, when a user has been playing other games since last playing the game at issue, the controls used on the other game) (s) may be referenced; if the controls in the other game map similar functions to different buttons (e.g. swapping jump and fire), then a weighting toward a more complete tutorial (or one including a basic revision of the controls) may similarly be provided.

### Tutorial Length

In a similar manner to plot recaps, optionally a desired length of a tutorial may be a factor in the selection of the tutorial. In this case, the interactive nature of a tutorial means there is less control over its duration, and this may also be less critical to the user as they are, in effect, immediately playing the game, just not in a manner that progresses them through the game proper.

However, data providing estimates of elapsed time for the completion of activities can be requested from a server; this can be based on telemetry from a cohort of other players who have completed the activity.

Accordingly an estimate of how long the tutorial will take can optionally be provided to the user. The user can then decide whether to proceed. Optionally where the tutorial comprises several activities, the user could opt via a UI to replace one or more activities with their associated helper video(s), on the basis that these will complete more quickly, The user can then interact with only a subset of the proposed activities.

In this way, a user can receive a tutorial that may simply remind them of how to interact with the game (for example if they have just been on holiday for a week) or may re-introduce key skills relevant to a problematic activity (if it is estimated that they player got stuck).

### Variants

In embodiments of the present description, a tutorial may be adaptive; for example if a user completes or progresses through a first activity proficiently, this may indicate that a subsequent activity is not necessary (for example if the user excels in an activity re-introducing a skill, a candidate activity for honing that skill may be dropped). Alternatively the candidate activity may be replaced with all of part of an associated helper video.

In embodiments of the present description, optionally a tutorial can use all or part of one or more helper videos (e.g. truncated as described elsewhere herein) associated with activities to re-introduce skills (for example where more than 1, 2, or more skills are considered useful to re-acquire), to speed up the tutorial process.

In embodiments of the present description, optionally a tutorial may be wholly non-interactive and comprise only videos (e.g. helper videos). Optionally this may use substantially the same scheme as described elsewhere herein for recap videos, but with alternative or additional metadata or labels indicative of tutorials rather than plot.

In embodiments of the present description, it will be appreciated that a user may benefit from both a plot recap and a tutorial.

Accordingly, in one instance these can be interwoven to provide a recap of the plot that also incorporates reminders of key skills, either as non-interactive helper videos or as interactive sandboxed activities, as described above. In effect this provides a high speed run through of key parts of the game with optional interactions to recover skills.

Helper videos may also be selected based on how often they are accessed by a cohort of players, as this is likely indicative of areas of the game that are more widely considered difficult. For example, a top M such videos that have not already been selected based on the user's own UDS and the techniques herein may be included.

As before, issues of recap/tutorial length may be considered. In this case, optionally the overall recap duration can be longer if it is broken up by interactive tutorial components; the recap length is primarily a consideration of how long the user may wish to wait before playing in the game, and the interactive parts meet this criterion. Hence the combined recap and tutorial may optionally last longer than either part on its own, as each provides a break from the other.

Hence in this case optionally a user's first returning play session could be offered as a fast-forward replay of their own game to that point, interleaving key plot points with tailored interactive practice.

### Summary

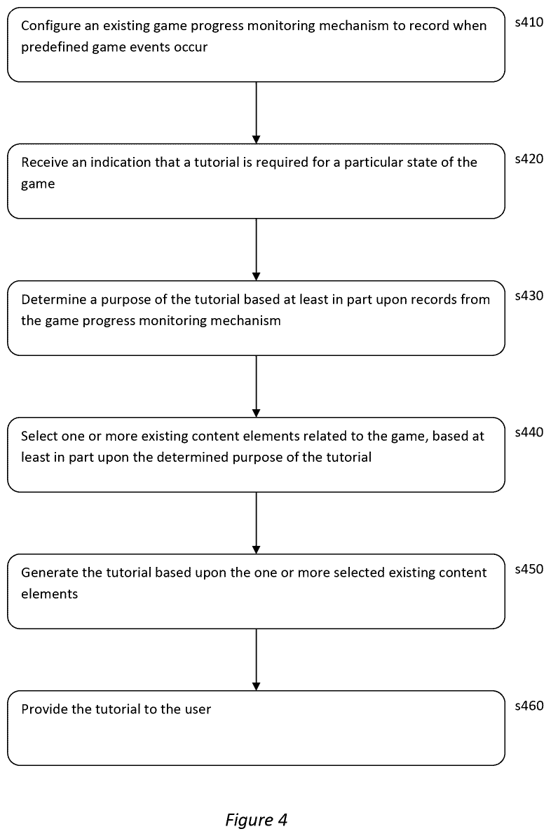

Referring now to FIG. 4, in a summary embodiment of the present description, a method of content generation to provide a tutorial to a user comprises the following steps.

In a first step s410, configuring an existing game progress monitoring mechanism (e.g. the UDS mechanism herein) to record when predefined game events occur (e.g. activities, their starts, ends, key moments, etc.), as described elsewhere herein.

In a second step s420, receiving an indication that a tutorial is required for a particular state of the game (e.g. when a threshold period of time has elapsed between game plays, or due to persistent failure to complete an activity, or due to a user setting, or due to a current user input), as described elsewhere herein.

In a third step s430, determining a purpose of the tutorial (e.g. a general reminder of game play, preparation for a next part of the game, or a reminder of one or more skills needed to overcome a part of the game the player is having difficulty with), based at least in part upon records from the game progress monitoring mechanism, as described elsewhere herein.

In a fourth step s440, selecting one or more existing content elements related to the game (e.g. predefined activities, helper videos, and the like), based at least in part upon the determined purpose of the tutorial (e.g. activities and videos providing a general reminder, preparation for next steps, or help with needed skills, or the like), as described elsewhere herein.

In a fifth step s450, generating the tutorial based upon the one or more selected existing content elements (for example, constructing a schedule or sequence of activities and/or videos, or requests for these), as described elsewhere herein.

And in a sixth step s460, providing the tutorial to the user (e.g. letting them interact with and/or view the tutorial contents, optionally setting up a sandbox for an in-game activity so it can operate like a tutorial, and the like), as described elsewhere herein.

It will be apparent to a person skilled in the art that variations in the above method corresponding to operation of the various embodiments of the apparatus as described and claimed herein are considered within the scope of the present invention, including but not limited to that:
the particular state of the game relates to when a save game to be loaded was created, as described elsewhere herein;
the step of selecting one or more existing content elements related to the game, for use in generating the tutorial, comprises selecting elements related to one or more selected from the list (A) consisting of the last activity of the user, the last activity completed by the user, the most popular activity within the N last activities played by the user, as indicated by data from a cohort of other users, a key skill related to the game, and a key skill related to part of the game as yet not played by the user, as described elsewhere herein;
the step of selecting one or more existing content elements related to the game, for use in generating the tutorial, comprises selecting elements related to one or more selected from the list (B) consisting of the most popular activity within the N last activities played by the user, as indicated by data from a cohort of other users, an incomplete activity within the last N activities played by the user, modified to assist completion by the user, and a key skill related to an incomplete activity within the last N activities played by the user, as described elsewhere herein;
the step of determining a purpose of the tutorial comprises one or more selected from the list consisting of estimating what the user was last doing in the game, based at least in part upon records from the game progress monitoring mechanism, and estimating what the user needs to do for a last activity, based at least in part upon records from the game progress monitoring mechanism, as described elsewhere herein;
the step of determining a purpose of the tutorial comprises estimating a reason why the user stopped playing the game, based at least in upon records from the game progress monitoring mechanism, as described elsewhere herein;
   in this case, then optionally if the estimated reason why the user stopped playing the game is not indicative of a threshold level of dissatisfaction, then the step of selecting one or more existing content elements related to the game, for use in generating the tutorial, is in accordance with list (A) above, otherwise it is in accordance with list (B) above, as described elsewhere herein;
one or more of the selected existing content elements are playable in-game activities defined as such for the game progress monitoring mechanism, as described elsewhere herein;
   in this case, optionally the one or more playable in-game activities are started in a sandbox mode that prevents the activity changing the state of the game in a manner that persists after the activity is stopped, as described elsewhere herein;
one or more of the selected existing content elements are help videos associated with activities defined as such for the game progress monitoring mechanism, as described elsewhere herein;
the step of selecting one or more existing content elements is responsive to one or more selected from the list consisting of how much time has passed since the user last played the game, what other game(s) the user has played since the user last played the game, an indication of a preferred tutorial duration, proficiency with a content element earlier in the tutorial, and how often other users have requested help relating to an existing content element, as described elsewhere herein;
the method comprises the steps of receiving an indication that recap content is required for a particular state of the game; compiling a list of recorded game events preceding the particular state of the game; accessing existing help videos associated through the game progress monitoring mechanism with listed game events; generating a recap video comprising at least part of one or more existing help videos; and outputting the recap video for viewing by a user, as described elsewhere herein; and
   in this case, optionally the step of outputting the recap video for viewing by the user and the step of providing the tutorial to the user are combined (e.g. interleaved), as described elsewhere herein.

Again it will be appreciated that the above methods may be carried out on hardware suitably adapted as applicable by software instruction or by the inclusion or substitution of dedicated hardware.

Thus the required adaptation to existing parts of an equivalent device may be implemented in the form of a computer program product comprising processor implementable instructions stored on a non-transitory machine-readable medium such as a floppy disk, optical disk, hard disk, solid state disk, PROM, RAM, flash memory or any combination of these or other storage media, or realised in hardware as an ASIC (application specific integrated circuit) or an FPGA (field programmable gate array) or other configurable circuit suitable to use in adapting the conventional equivalent device. Separately, such a computer program may be transmitted via data signals on a network such as an Ethernet, a wireless network, the Internet, or any combination of these or other networks.

Accordingly, and referring again to FIG. 1, in a summary embodiment of the present description, an entertainment device 10 (either local to the user, or as part of a cloud gaming service), for providing a tutorial to a user, comprises the following.

An existing game progress monitoring mechanism (e.g. the UDS of the OS, running for example on CPU 20), configured (e.g. by suitable software instruction) to record when predefined game events occur, as described elsewhere herein.

A processor (e.g. CPU 20) configured to (e.g. by suitable software instruction) receive an indication that a tutorial is required for a particular state of the game, as described elsewhere herein.

A determination processor (e.g. CPU 20) configured (e.g. by suitable software instruction) to determine a purpose of the tutorial (e.g. a general reminder of game play, preparation for a next part of the game, or a reminder of one or more skills needed to overcome a part of the game the player is having difficulty with) based at least in part upon records from the game progress monitoring mechanism, as described elsewhere herein.

A selection processor (e.g. CPU 20) configured (e.g. by suitable software instruction) to select one or more existing content elements related to the game (e.g. predefined activities, helper videos, and the like), based at least in part upon the determined purpose of the tutorial (e.g. activities and videos providing a general reminder, preparation for next steps, or help with needed skills, or the like), as described elsewhere herein.

A generation processor (e.g. CPU 20) configured (e.g. by suitable software instruction) to generate the tutorial based upon the one or more selected existing content elements (for example, constructing a schedule or sequence of activities and/or videos, or requests for these), as described elsewhere herein.

And an output processor (e.g. CPU 20) configured (e.g. by suitable software instruction) to provide the tutorial to the user (e.g. letting them interact with and/or view the tutorial contents, optionally setting up a sandbox for an in-game activity so it can operate like a tutorial, and the like), as described elsewhere herein.

Instances of this summary embodiment implementing the methods and techniques described herein (for example by use of suitable software instruction) are also envisaged within the scope of the application.

The foregoing discussion discloses and describes merely exemplary embodiments of the present invention. As will be understood by those skilled in the art, the present invention may be embodied in other specific forms without departing from the spirit or essential characteristics thereof. Accordingly, the disclosure of the present invention is intended to be illustrative, but not limiting of the scope of the invention, as well as other claims. The disclosure, including any readily discernible variants of the teachings herein, defines, in part, the scope of the foregoing claim terminology such that no inventive subject matter is dedicated to the public.

1. A method of content generation to provide a tutorial to a user, the method comprising:
configuring an existing game progress monitoring mechanism to record when predefined game events occur;
receiving an indication that a tutorial is required for a particular state of the game;
determining a purpose of the tutorial based at least in part upon records from the game progress monitoring mechanism;
selecting one or more existing content elements related to the game, based at least in part upon the determined purpose of the tutorial;
generating the tutorial based upon the one or more selected existing content elements; and
providing the tutorial to the user.

2. The method of claim 1 wherein the particular state of the game relates to when a save game to be loaded was created.

3. The method of claim 1, wherein selecting one or more existing content elements related to the game, for use in generating the tutorial, comprises:
selecting elements related to one or more selected from the list consisting of:
i. the last activity of the user;
ii. the last activity completed by the user;
iii. the most popular activity within the N last activities played by the user, as indicated by data from a cohort of other users;
iv. a key skill related to the game; and
v. a key skill related to part of the game as yet not played by the user.

4. The method of claim 1, wherein selecting one or more existing content elements related to the game, for use in generating the tutorial, comprises:
selecting elements related to one or more selected from the list consisting of:
i. the most popular activity within the N last activities played by the user, as indicated by data from a cohort of other users;
ii. an incomplete activity within the last N activities played by the user, modified to assist completion by the user; and
iii. a key skill related to an incomplete activity within the last N activities played by the user.

5. The method of claim 1, wherein determining a purpose of the tutorial comprises:
one or more selected from the list consisting of:
i. estimating what the user was last doing in the game, based at least in part upon records from the game progress monitoring mechanism; and
ii. estimating what the user needs to do for a last activity, based at least in part upon records from the game progress monitoring mechanism.

6. The method of claim 1, wherein determining a purpose of the tutorial comprises:
estimating a reason why the user stopped playing the game, based at least in upon records from the game progress monitoring mechanism.

7. The method of claim 6, further comprising:
if the estimated reason why the user stopped playing the game is not indicative of a threshold level of dissatisfaction, selecting one or more existing content elements related to the game, for use in generating the tutorial.

8. The method of claim 1, wherein one or more of the selected existing content elements are playable in-game activities defined as such for the game progress monitoring mechanism.

9. The method of claim 8 in which the one or more playable in-game activities are started in a sandbox mode that prevents the activity changing the state of the game in a manner that persists after the activity is stopped.

10. The method of claim 1, wherein one or more of the selected existing content elements are help videos associated with activities defined as such for the game progress monitoring mechanism.

11. The method of claim 1, wherein selecting one or more existing content elements is responsive to one or more selected from the list consisting of:
i. how much time has passed since the user last played the game;
ii. what other game(s) the user has played since the user last played the game;
iii. an indication of a preferred tutorial duration;
iv. proficiency with a content element earlier in the tutorial; and
v. how often other users have requested help relating to an existing content element.

12. The method of claim 1, further comprising:
receiving an indication that recap content is required for a particular state of the game;
compiling a list of recorded game events preceding the particular state of the game;
accessing existing help videos associated through the game progress monitoring mechanism with listed game events;
generating a recap video comprising at least part of one or more existing help videos; and
outputting the recap video for viewing by a user.

13. The method of claim 12, in which
the step of outputting the recap video for viewing by the user and the step of providing the tutorial to the user are combined.

14. An entertainment device for providing a tutorial to a user, comprising:
a game progress monitoring mechanism, configured to record when predefined game events occur;
a processor configured to receive an indication that a tutorial is required for a particular state of the game;
a determination processor configured to determine a purpose of the tutorial based at least in part upon records from the game progress monitoring mechanism;
a selection processor configured to select one or more existing content elements related to the game, based at least in part upon the determined purpose of the tutorial;
a generation processor configured to generate the tutorial based upon the one or more selected existing content elements; and
an output processor configured to provide the tutorial to the user.

15. The device of claim 14, wherein the particular state of the game relates to when a save game to be loaded was created.

16. The device of claim 14, wherein selecting one or more existing content elements related to the game, for use in generating the tutorial, comprises:
selecting elements related to one or more selected from the list consisting of:
i. the last activity of the user;
ii. the last activity completed by the user;
iii. the most popular activity within the N last activities played by the user, as indicated by data from a cohort of other users;
iv. a key skill related to the game; and
v. a key skill related to part of the game as yet not played by the user.

17. One or more non-transitory storage media storing instructions that when executed by one or more computers cause the one or more computers to perform operations comprising:
configuring an existing game progress monitoring mechanism to record when predefined game events occur;
receiving an indication that a tutorial is required for a particular state of the game;
determining a purpose of the tutorial based at least in part upon records from the game progress monitoring mechanism;
selecting one or more existing content elements related to the game, based at least in part upon the determined purpose of the tutorial;
generating the tutorial based upon the one or more selected existing content elements; and
providing the tutorial to the user.

18. The one or more non-transitory media of claim 17, wherein the particular state of the game relates to when a save game to be loaded was created.

19. The one or more non-transitory media of claim 17, wherein selecting one or more existing content elements related to the game, for use in generating the tutorial, comprises:
selecting elements related to one or more selected from the list consisting of:
i. the last activity of the user;
ii. the last activity completed by the user;
iii. the most popular activity within the N last activities played by the user, as indicated by data from a cohort of other users;
iv. a key skill related to the game; and
v. a key skill related to part of the game as yet not played by the user.
